(19) United States
(12) Patent Application Publication
(10) Pub. No.: US 2006/0233682 A1
(43) Pub. Date: Oct. 19, 2006

(54) Plasma-assisted engine exhaust treatment

(76) Inventors: Kuruvilla A. Cherian, Rochester Hills, MI (US); Devendra Kumar, Rochester Hills, MI (US); Satyendra Kumar, Troy, MI (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/513,606

(22) PCT Filed: May 7, 2003
(86) PCT No.: PCT/US03/14035

§ 371 Date: Feb. 10, 2006

Related U.S. Application Data
(60) Provisional application No. 60/378,693, filed on May 8, 2002.
(60) Provisional application No. 60/430,677, filed on Dec. 4, 2002.
(60) Provisional application No. 60/432,278, filed on Dec. 9, 2002.

(51) Int. Cl. B01J 19/08

(52) U.S. Cl. 422/186

(57) ABSTRACT

Methods and apparatus are provided for plasma-assisted engine exhaust treatment. In one embodiment, an engine exhaust treatment system includes at least one conduit with an inlet portion (215), an outlet portion (216), an intermediate portion (205), and at least one plasma cavity (210). The inlet portion is configured to connect to an engine block (510) and receive an exhaust gas. The outlet portion emits the exhaust gas after plasma treatment. The intermediate portion conveys the exhaust gas from the inlet portion to the outlet portion. In one embodiment, one or more plasma cavities (342, 344, 346) are located proximate to the inlet portion for treating the exhaust gas. The system also includes an electromagnetic radiation source (340) connected to the cavities for supplying radiation to the cavities, wherein the radiation has a frequency less than about 333 GHz. Exhaust gas treatments that use plasma catalysts (70, 170) are also provided.

### CROSS-REFERENCE OF RELATED APPLICATIONS

Priority is claimed to U.S. Provisional Patent Application No. 60/378,693, filed May 8, 2002, Ser. No. 60/430,677, filed Dec. 4, 2002, and Ser. No. 60/435,278, filed Dec. 23, 2002, all of which are fully incorporated herein by reference.

### FIELD OF THE INVENTION

This invention relates to methods and apparatus for treating engine exhaust gases and, in particular, igniting, modulating, and sustaining plasmas formed from engine exhaust gases, in some cases using plasma catalysts.

### BACKGROUND OF THE INVENTION

It is known that plasmas can be used to treat engine exhaust gases. For example, it has been reported that nitrogen and carbon compounds, as well as particulates from diesel exhaust, can be reduced using a combination of plasma with a catalyst in this context, a catalyst is used to catalyze the reduction process, not the plasma itself.

Non-thermal plasmas can be formed by directing electrical energy to create free electrons, which in turn can react with gaseous species. The combination of non-thermal plasmas with catalysts has been referred to as “Plasma Assisted Catalysis,” but is usually carried out in the presence of NH₃ as a reductant. During operation, NO has been reportedly oxidized to HNO₃ and then into ammonium nitrate, and then condensed and removed. Such a process may not, however, lend itself to mobile exhaust treatment for a number of reasons, including the handling of ammonia and the extensive equipment required to actually perform the treatment.

In general, thermal plasmas are formed by heating a system to high temperatures (e.g., greater than about 2,000 degrees Celsius), however this can be inefficient and can require extensive thermal management. As a result, thermal plasmas are often considered impractical for mobile applications.

It is also known that a plasma can be ignited by subjecting a gas to a sufficient amount of electromagnetic radiation. Plasma ignition, however, is usually easier at gas pressures substantially less than atmospheric pressure, which requires vacuum equipment that can be expensive, slow, and energy-consuming. Moreover, the use of such equipment can limit plasma-assisted exhaust treatment flexibility.

### BRIEF SUMMARY OF A FEW ASPECTS OF THE INVENTION

Methods and apparatus for plasma-assisted exhaust gas treatment may be provided consistent with this invention.

In one embodiment, an engine exhaust treatment system can be provided consistent with this invention. The system can include at least one conduit that includes: (1) an inlet portion configured to connect to an engine block and receive an engine exhaust gas, (2) an outlet portion for emitting the gas, (3) an intermediate portion for conveying the gas from the inlet portion to the outlet portion, and (4) at least one plasma cavity located proximate the inlet portion for treating the gas. The system can also include an electromagnetic radiation source connected to the cavity for supplying radiation to the cavity, wherein the radiation has a frequency less than about 333 GHz.

Another engine exhaust treatment system can be provided consistent with this invention. The system can include at least one conduit that includes: (1) an inlet portion configured to connect to an engine block and receive an engine exhaust gas, (2) an outlet portion for emitting the gas, and (3) an intermediate portion for conveying the gas from the inlet portion to the outlet portion and having internal dimensions configured to support at least one electromagnetic radiation mode for forming a plasma therein from the exhaust gas in the presence of a plasma catalyst. The system can also include a source for supplying electromagnetic radiation to the intermediate portion, wherein the radiation has a frequency less than about 333 GHz.

A method for treating engine exhaust gas can also be provided consistent with this invention. The method can include forming at least one plasma from an engine exhaust gas by subjecting the exhaust gas to electromagnetic radiation having a frequency less than about 333 GHz, optionally in the presence of a plasma catalyst in at least one cavity.

Plasma catalysts for initiating, modulating, and sustaining plasmas are also provided. A plasma catalyst can be passive or active. A passive plasma catalyst can include any object capable of inducing a plasma by deforming a local electric field (e.g., an electromagnetic field) consistent with this invention, without necessarily adding additional energy. An active plasma catalyst, on the other hand, is any particle or high energy wave packet capable of transferring a sufficient amount of energy to a gaseous atom or molecule to remove at least one electron from the gaseous atom or molecule in the presence of electromagnetic radiation. In both cases, a plasma catalyst can improve, or relax, the environmental conditions required to ignite plasmas.

Additional plasma catalysts, and methods and apparatus for igniting, modulating, and sustaining plasmas consistent with this invention are also provided.

### BRIEF DESCRIPTION OF THE DRAWINGS

Further aspects of the invention will be apparent upon consideration of the following detailed description, taken in conjunction with the accompanying drawings, in which like reference characters refer to like parts throughout, and in which:

FIG. 1 shows a schematic diagram of an illustrative plasma system consistent with this invention;

FIG. 1A shows an illustrative embodiment of a portion of a plasma system for adding a powder plasma catalyst to a plasma cavity for igniting, modulating, or sustaining a plasma in a cavity consistent with this invention;

FIG. 2 shows an illustrative plasma catalyst fiber with at least one component having a concentration gradient along its length consistent with this invention;

FIG. 3 shows an illustrative plasma catalyst fiber with multiple components at a ratio that varies along its length consistent with this invention;

FIG. 4 shows another illustrative plasma catalyst fiber that includes a core underlayer and a coating consistent with this invention;

FIG. 5 shows a cross-sectional view of the plasma catalyst fiber of FIG. 4, taken from line 5-5 of FIG. 4 consistent with this invention;

FIG. 6 shows an illustrative embodiment of another portion of a plasma system including an elongated plasma catalyst that extends through ignition port consistent with this invention;

FIG. 7 shows an illustrative embodiment of an elongated plasma catalyst that can be used in the system of FIG. 6 consistent with this invention;

FIG. 8 shows another illustrative embodiment of an elongated plasma catalyst that can be used in the system of FIG. 6 consistent with this invention;

FIG. 9 shows an illustrative embodiment of a portion of a plasma system for directing radiation into a radiation chamber consistent with this invention;

FIG. 10 shows a simplified schematic diagram of an illustrative engine exhaust treatment system consistent with this invention;

FIG. 11 shows another simplified schematic diagram of an illustrative engine exhaust treatment system consistent with this invention;

FIG. 12 shows yet another simplified schematic diagram an illustrative engine exhaust treatment system consistent with this invention; and

FIG. 13 shows a simplified schematic view of an illustrative mobile vehicle, in this case an automobile, which includes an exhaust treatment system consistent with this invention.

### DETAILED DESCRIPTION OF THE EMBODIMENTS

This invention may relate to methods and apparatus for initiating, modulating, and sustaining a plasma for plasma-assisted engine exhaust treatment. Thus, this invention can be used for controlled plasma-assisted exhaust treatments to lower energy costs and increase treatment efficiency and flexibility.

The following commonly owned, concurrently filed U.S. patent applications are hereby incorporated by reference in their entireties: U.S. patent application Ser. No. 10/___,___, (Atty. Docket No. 1837.0008), Ser. No. 10/___,___, (Atty. Docket No. 1837.0009), Ser. No. 10/___,___, (Atty. Docket No. 1837.0010), Ser. No. 10/___,___, (Atty. Docket No. 1837.0011), Ser. No. 10/___,___, (Atty. Docket No. 1837.0012), Ser. No. 10/___,___ (Atty. Docket No. 1837.0013), Ser. No. 10/___,___ (Atty. Docket No. 1837.0015), Ser. No. 10/___,___, (Atty. Docket No. 1837.0016), Ser. No. 10/___,___ (Atty. Docket No. 1837.0017), Ser. No. 10/___,___ (Atty. Docket No. 1837.0018), Ser. No. 10/___,___ (Atty. Docket No. 1837.0020), Ser. No. 10/___,___ (Atty. Docket No. 1837.0023), Ser. No. 10/___,___, (Atty. Docket No. 1837.0024), Ser. No. 10/___,___ (Atty. Docket No. 1837.0025), Ser. No. 10/___,___ (Atty. Docket No. 1837.0026), Ser. No. 10/___,___ (Atty. Docket No. 1837.0027), Ser. No. 10/___,___ (Atty. Docket No. 1837.0028), Ser. No. 10/___,___ (Atty. Docket No. 1837.0029), Ser. No. 10/___,___ (Atty. Docket No. 1837.0030), Ser. No. 10/___,___ (Atty. Docket No. 1837.0032), and Ser. No. 10/___,___ (Atty. Docket No. 1837.0033).

Illustrative Plasma System

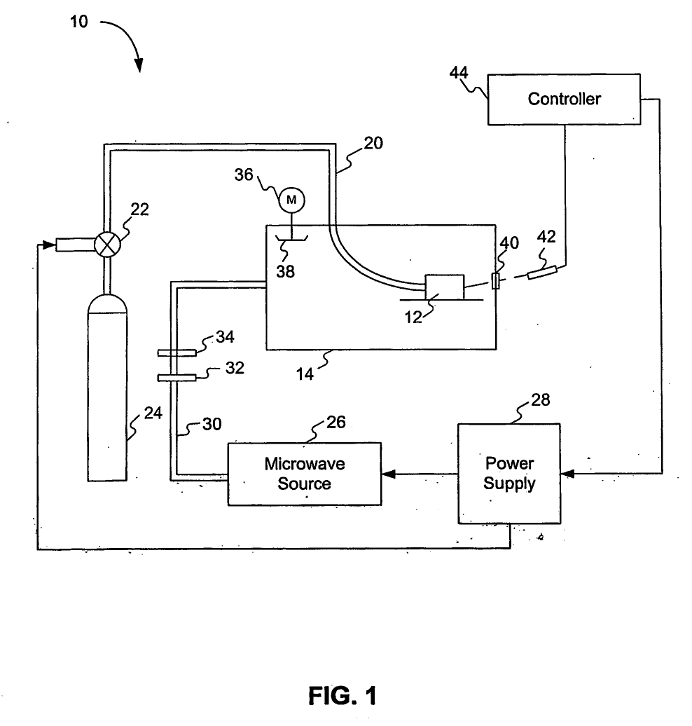

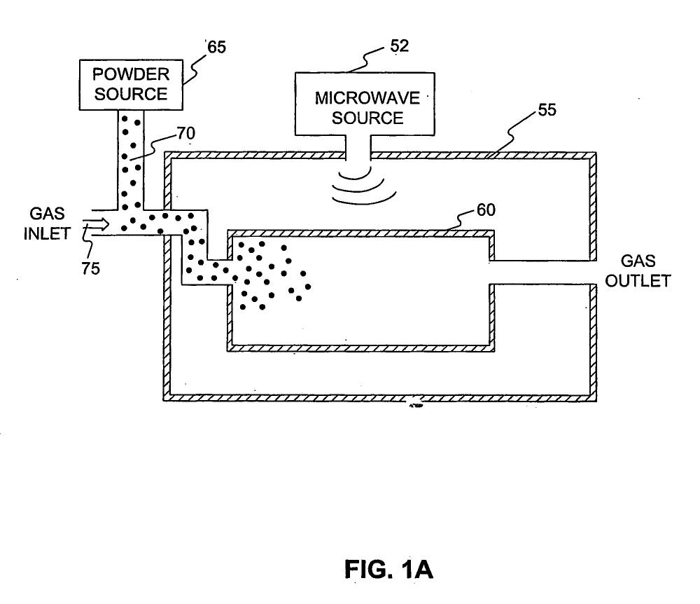

FIG. 1 shows illustrative plasma system 10 consistent with one aspect of this invention. In this embodiment, cavity 12 is formed in a vessel that is positioned inside radiation chamber (i.e., applicator) 14. In another embodiment (not shown), vessel 12 and radiation chamber 14 are the same, thereby eliminating the need for two separate components. The vessel in which cavity 12 is formed can include one or more radiation-transmissive insulating layers to improve its thermal insulation properties without significantly shielding cavity 12 from the radiation.

In one embodiment, cavity 12 is formed in a vessel made of ceramic. Due to the extremely high temperatures that can be achieved with plasmas consistent with this invention, a ceramic capable of operating at about 3,000 degrees Fahrenheit can be used. The ceramic material can include, by weight, 29.8% silica, 68.2% alumina, 0.4% ferric oxide, 1% titania, 0.1% lime, 0.1% magnesia, 0.4% alkalies, which is sold under Model No. LW-30 by New Castle Refractories Company, of New Castle, Pa. It will be appreciated by those of ordinary skill in the art, however, that other materials, such as quartz, and those different from the one described above, can also be used consistent with the invention.

In one successful experiment, a plasma was formed in a partially open cavity inside a first brick and topped with a second brick. The cavity had dimensions of about 2 inches by about 2 inches by about 1.5 inches. At least two holes were also provided in the brick in communication with the cavity: one for viewing the plasma and at least one hole for providing the gas. The size of the cavity can depend on the desired plasma process being performed. Also, the cavity should at least be configured to prevent the plasma from rising/floating away from the primary processing region. It will be appreciated that a plasma can be formed consistent with this invention without placing electrodes in the vicinity of the plasma itself.

Cavity 12 can be connected to one or more gas sources 24 (e.g., a source of argon, nitrogen, hydrogen, xenon, krypton) by line 20 and control valve 22, which may be powered by power supply 28. Line 20 may be tubing (e.g., between about 1/16 inch and about ¼ inch, such as about ⅛″). Also, if desired, a vacuum pump can be connected to the chamber to remove any fumes that may be generated during plasma processing. In the case of exhaust gas treatment, the gas can be provided directly or indirectly from an engine block. Thus, gas lines and vacuum equipment are optional.

A radiation leak detector (not shown) was installed near source 26 and waveguide 30 and connected to a safety interlock system to automatically turn off the radiation (e.g., microwave) power supply if a leak above a predefined safety limit, such as one specified by the FCC and/or OSHA (e.g., 5 mW/cm²), was detected.

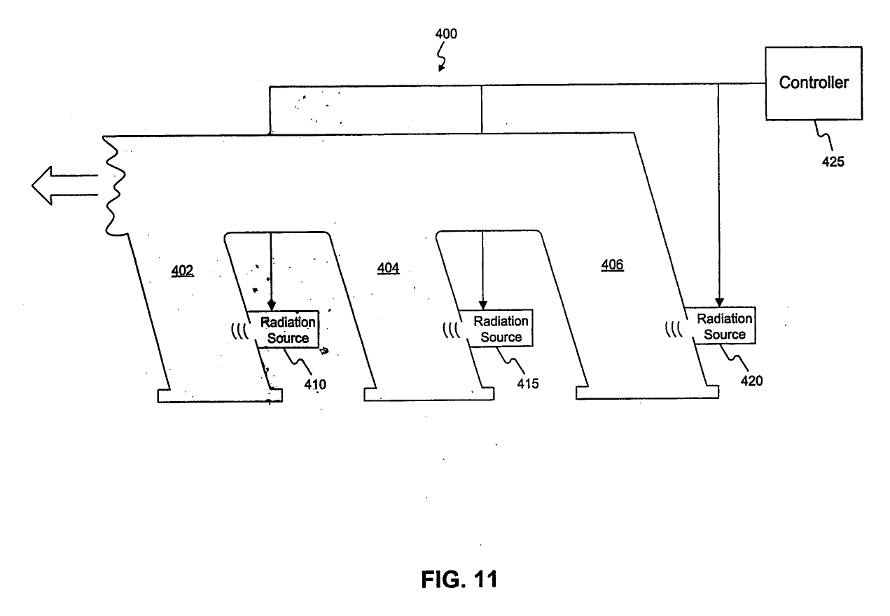

Radiation source 26, which may be powered by electrical power supply 28, directs radiation energy into chamber 14 through one or more waveguides 30 (see, e.g., FIG. 11). It will be appreciated by those of ordinary skill in the art that source 26 can be connected directly to cavity 12, thereby eliminating waveguide 30. The radiation energy entering cavity 12 can be used to ignite a plasma within the cavity. This plasma can be substantially sustained and confined to the cavity by coupling additional radiation with the catalyst.

Radiation energy can be supplied through circulator 32 and tuner 34 (e.g., 3-stub tuner). Tuner 34 can be used to minimize the reflected power as a function of changing ignition or processing conditions, especially before the plasma has formed because microwave power, for example, will be strongly absorbed by the plasma.

As explained more fully below, the location of radiation-transmissive cavity 12 in chamber 14 may not be critical if chamber 14 supports multiple modes, and especially when the modes are continually or periodically mixed. Also, when chamber 14 is the exhaust manifold of an engine, cavity 12 can simply be a thermal lining, or can be eliminated entirely, if desired. As also explained more fully below, motor 36 can be connected to mode-mixer 38 for making the time-averaged radiation energy distribution substantially uniform throughout chamber 14. Furthermore, window 40 (e.g., a quartz window) can be disposed in one wall of chamber 14 adjacent to cavity 12, permitting temperature sensor 42 (e.g., an optical pyrometer) to be used to view a process inside cavity 12. In one embodiment, the optical pyrometer output can increase from zero volts as the temperature rises to within the tracking range.

Sensor 42 can develop output signals as a function of the temperature or any other monitorable condition associated with a work piece (not shown) within cavity 12 and provide the signals to controller 44. Dual temperature sensing and heating, as well as automated cooling rate and gas flow controls can also be used. Controller 44 in turn can be used to control operation of power supply 28, which can have one output connected to source 26 as described above and another output connected to valve 22 to control gas flow into cavity 12.

The invention has been practiced with equal success employing microwave sources at both 915 MHz and 2.45 GHz provided by Communications and Power Industries (CPI), although radiation having any frequency less than about 333 GHz can be used. The 2.45 GHz system provided continuously variable microwave power from about 0.5 kilowatts to about 5.0 kilowatts. A 3-stub tuner allowed impedance matching for maximum power transfer and a dual directional coupler (not shown) was used to measure forward and reflected powers. Also, optical pyrometers were used for remote sensing of the sample temperature.

As mentioned above, radiation having any frequency less than about 333 GHz can be used consistent with this invention. For example, frequencies, such as power line frequencies (about 50 Hz to about 60 Hz), can be used, although the pressure of the gas from which the plasma is formed may be lowered to assist with plasma ignition. Also, any radio frequency or microwave frequency can be used consistent with this invention, including frequencies greater than about 100 kHz. In most cases, the gas pressure for such relatively high frequencies need not be lowered to ignite, modulate, or sustain a plasma, thereby enabling many plasma-processes to occur at atmospheric pressures and above.

The equipment was computer controlled using LabView 6i software, which provided real-time temperature monitoring and microwave power control. Noise was reduced by using sliding averages of suitable number of data points. Also, to improve speed and computational efficiency, the number of stored data points in the buffer array were limited by using shift registers and buffer sizing. The pyrometer measured the temperature of a sensitive area of about 1 cm², which was used to calculate an average temperature. The pyrometer sensed radiant intensities at two wavelengths and fit those intensities using Planck's law to determine the temperature. It will be appreciated, however, that other devices and methods for monitoring and controlling temperature are also available and can be used consistent with this invention. Control software that can be used consistent with this invention is described, for example, in commonly owned, concurrently filed U.S. patent application Ser. No. 10/___,___ (Attorney Docket No. 1837.0033), which is hereby incorporated by reference in its entirety.

Chamber 14 had several glass-covered viewing ports with radiation shields and one quartz window for pyrometer access. Several ports for connection to a vacuum pump and a gas source were also provided, although not necessarily used.

System 10 also included a closed-loop deionized water cooling system (not shown) with an external heat exchanger cooled by tap water. During operation, the deionized water first cooled the magnetron, then the load-dump in the circulator (used to protect the magnetron), and finally the radiation chamber through water channels welded on the outer surface of the chamber.

Plasma Catalysts

A plasma catalyst consistent with this invention can include one or more different materials and may be either passive or active. A plasma catalyst can be used, among other things, to ignite, modulate, and/or sustain a plasma at a gas pressure that is less than, equal to, or greater than atmospheric pressure.

One method of forming a plasma consistent with this invention can include subjecting an exhaust gas in a cavity to electromagnetic radiation having a frequency less than about 333 GHz in the presence of a passive plasma catalyst. A passive plasma catalyst consistent with this invention can include any object capable of inducing a plasma by deforming a local electric field (e.g., an electromagnetic field) consistent with this invention, without necessarily adding additional energy through the catalyst, such as by applying an electric voltage to create a spark.

A passive plasma catalyst consistent with this invention can also be a nano-particle or a nano-tube. As used herein, the term “nano-particle” can include any particle having a maximum physical dimension less than about 100 nm that is at least electrically semi-conductive. Also, both single-walled and multi-walled carbon nanotubes, doped and undoped, can be particularly effective for igniting plasmas consistent with this invention because of their exceptional electrical conductivity and elongated shape. The nanotubes can have any convenient length and can be a powder fixed to a substrate. If fixed, the nanotubes can be oriented randomly on the surface of the substrate or fixed to the substrate (e.g., at some predetermined orientation) while the plasma is ignited or sustained.

A passive plasma catalyst can also be a powder consistent with this invention, and need not comprise nano-particles or nano-tubes. It can be formed, for example, from fibers, dust particles, flakes, sheets, etc. When in powder form, the catalyst can be suspended, at least temporarily, in a gas. By suspending the powder in the gas, the powder can be quickly dispersed throughout the cavity and more easily consumed, if desired.

In one embodiment, the powder catalyst can be carried into the cavity and at least temporarily suspended with a carrier gas. The carrier gas can be the same or different from the exhaust gas that forms the plasma. Also, the powder can be added to the gas prior to being introduced to the cavity. For example, as shown in FIG. 1A, radiation source 52 can supply radiation to radiation cavity 55, in which plasma cavity 60 is placed. Powder source 65 provides catalytic powder 70 into gas stream 75. In an alternative embodiment, powder 70 can be first added to cavity 60 in bulk (e.g., in a pile) and then distributed in the cavity in any number of ways, including flowing a gas through or over the bulk powder. In addition, the powder can be added to the gas for igniting, modulating, or sustaining a plasma by moving, conveying, drizzling, sprinkling, blowing, or otherwise, feeding the powder into or within the cavity.

In one experiment, a plasma was ignited in a cavity by placing a pile of carbon fiber powder in a copper pipe that extended into the cavity. Although sufficient radiation was directed into the cavity, the copper pipe shielded the powder from the radiation and no plasma ignition took place. However, once a carrier gas began flowing through the pipe, forcing the powder out of the pipe and into the cavity, and thereby subjecting the powder to the radiation, a plasma was nearly instantaneously ignited in the cavity.

A powder plasma catalyst consistent with this invention can be substantially non-combustible, thus it need not contain oxygen or burn in the presence of oxygen. Thus, as mentioned above, the catalyst can include a metal, carbon, a carbon-based alloy, a carbon-based composite, an electrically conductive polymer, a conductive silicone elastomer, a polymer nanocomposite, an organic-inorganic composite, and any combination thereof.

Also powder catalysts can be substantially uniformly distributed in the plasma cavity (e.g., when suspended in a gas), and plasma ignition can be precisely controlled within the cavity. Uniform ignition can be important in certain applications, including those applications requiring brief plasma exposures, such as in the form of one or more bursts. Still, a certain amount of time can be required for a powder catalyst to distribute itself throughout a cavity, especially in complicated, multi-chamber cavities. Therefore, consistent with another aspect of this invention, a powder catalyst can be introduced into the cavity through a plurality of ignition ports to more rapidly obtain a more uniform catalyst distribution therein (see below).

In addition to powder, a passive plasma catalyst consistent with this invention can include, for example, one or more microscopic or macroscopic fibers, sheets, needles, threads, strands, filaments, yarns, twines, shavings, slivers, chips, woven fabrics, tape, whiskers, or any combination thereof. In these cases, the plasma catalyst can have at least one portion with one physical dimension substantially larger than another physical dimension. For example, the ratio between at least two orthogonal dimensions should be at least about 1:2, but could be greater than about 1:5, or even greater than about 1:10.

Thus, a passive plasma catalyst can include at least one portion of material that is relatively thin compared to its length. A bundle of catalysts (e.g., fibers) may also be used and can include, for example, a section of graphite tape. In one experiment, a section of tape having approximately thirty thousand strands of graphite fiber, each about 2-3 microns in diameter, was successfully used. The number of fibers in and the length of a bundle are not critical to igniting, modulating, or sustaining the plasma. For example, satisfactory results have been obtained using a section of graphite tape about one-quarter inch long. One type of carbon fiber that has been successfully used consistent with this invention is sold under the trademark Magnamite®, Model No. AS4C-GP3K, by the Hexcel Corporation, of Anderson, S.C. Also, silicon-carbide fibers have been successfully used.

A passive plasma catalyst consistent with another aspect of this invention can include one or more portions that are, for example, substantially spherical, annular, pyramidal, cubic, planar, cylindrical, rectangular or elongated.

The passive plasma catalysts discussed above include at least one material that is at least electrically semi-conductive. In one-embodiment, the material can be highly conductive. For example, a passive plasma catalyst consistent with this invention can include a metal, an inorganic material, carbon, a carbon-based alloy, a carbon-based composite, an electrically conductive polymer, a conductive silicone elastomer, a polymer nanocomposite, an organic-inorganic composite, or any combination thereof. Some of the possible inorganic materials that can be included in the plasma catalyst include carbon, silicon carbide, molybdenum, platinum, tantalum, tungsten, carbon nitride, and aluminum, although other electrically conductive inorganic materials are believed to work just as well.

In addition to one or more electrically conductive materials, a passive plasma catalyst consistent with this invention can include one or more additives (which need not be electrically conductive). As used herein, the additive can include any material that a user wishes to add to the plasma. For example, in doping semiconductors and other materials, one or more dopants can be added to the plasma through the catalyst. See, e.g., commonly owned, concurrently filed U.S. patent application Ser. No. 10/___,___ (Attorney Docket No. 1837.0026), which is hereby incorporated by reference in its entirety. The catalyst can include the dopant itself, or it can include a precursor material that, upon decomposition, can form the dopant. Thus, the plasma catalyst can include one or more additives and one or more electrically conductive materials in any desirable ratio, depending on the ultimate desired composition of the plasma and the process using the plasma.

The ratio of the electrically conductive components to the additives in a passive plasma catalyst can vary over time while being consumed. For example, during ignition, the plasma catalyst could desirably include a relatively large percentage of electrically conductive components to improve the ignition conditions. On the other hand, if used while sustaining the plasma, the catalyst could include a relatively large percentage of additives. It will be appreciated by those of ordinary skill in the art that the component ratio of the plasma catalyst used to ignite and sustain the plasma could be the same.

A predetermined ratio profile can be used to simplify many plasma processes. In many conventional plasma processes, the components within the plasma are added as necessary, but such addition normally requires programmable equipment to add the components according to a predetermined schedule. However, consistent with this invention, the ratio of components in the catalyst can be varied, and thus the ratio of components in the plasma itself can be automatically varied. That is, the ratio of components in the plasma at any particular time can depend on which of the catalyst portions is currently being consumed by the plasma. Thus, the catalyst component ratio can be different at different locations within the catalyst. And, the current ratio of components in a plasma can depend on the portions of the catalyst currently and/or previously consumed, especially when the flow rate of a gas passing through the plasma chamber is relatively slow.

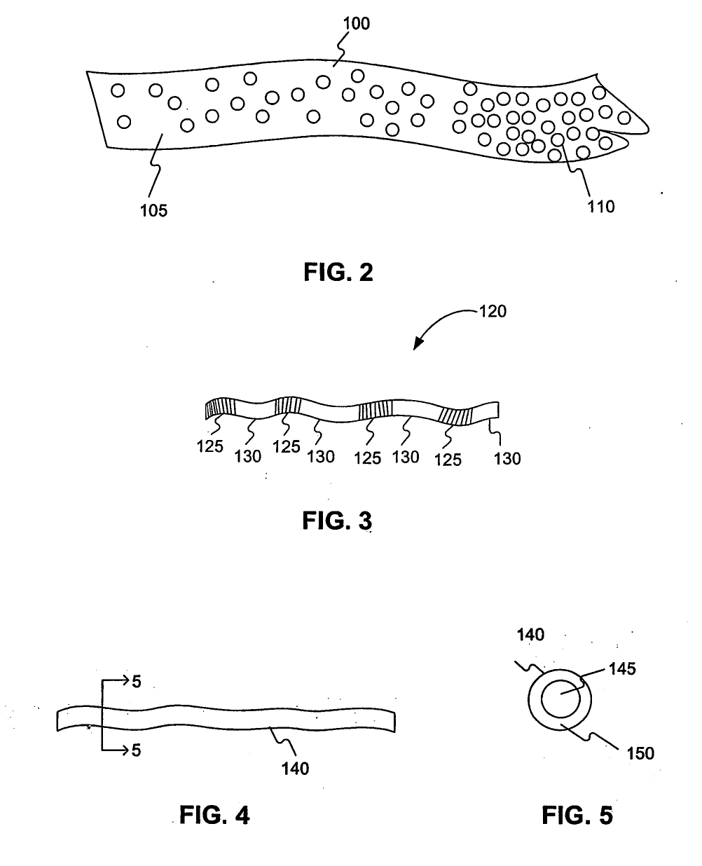

A passive plasma catalyst consistent with this invention can be homogeneous, inhomogeneous, or graded. Also, the plasma catalyst component ratio can vary continuously or discontinuously throughout the catalyst. For example, in FIG. 2, the ratio can vary smoothly forming a gradient along a length of catalyst 100. Catalyst 100 can include a strand of material that includes a relatively low concentration of a component at section 105 and a continuously increasing concentration toward section 110.

Alternatively, as shown in FIG. 3, the ratio can vary discontinuously in each portion of catalyst 120, which includes, for example, alternating sections 125 and 130 having different concentrations. It will be appreciated that catalyst 120 can have more than two section types. Thus, the catalytic component ratio being consumed by the plasma can vary in any predetermined fashion. In one embodiment, when the plasma is monitored and a particular additive is detected, further processing can be automatically commenced or terminated.

Another way to vary the ratio of components in a modulated or sustained plasma is by introducing multiple catalysts having different component ratios at different times or different rates. For example, multiple catalysts can be introduced at approximately the same location or at different locations within the cavity. When introduced at different locations, the plasma formed in the cavity can have a component concentration gradient determined by the locations of the various catalysts. Thus, an automated system can include a device by which a consumable plasma catalyst is mechanically inserted before and/or during plasma igniting, modulating, and/or sustaining.

A passive plasma catalyst consistent with this invention can also be coated. In one embodiment, a catalyst can include a substantially nonelectrically conductive coating deposited on the surface of a substantially electrically conductive material. Alternatively, the catalyst can include a substantially electrically conductive coating deposited on the surface of a substantially electrically non-conductive material. FIGS. 4 and 5, for example, show fiber 140, which includes underlayer 145 and coating 150. In one embodiment, a plasma catalyst including a carbon core is coated with nickel to prevent oxidation of the carbon.

A single plasma catalyst can also include multiple coatings. If the coatings are consumed during contact with the plasma, the coatings could be introduced into the plasma sequentially, from the outer coating to the innermost coating, thereby creating a time-release mechanism. Thus, a coated plasma catalyst can include any number of materials, as long as a portion of the catalyst is at least electrically semi-conductive.

Consistent with another embodiment of this invention, a plasma catalyst can be located entirely within a radiation cavity to substantially reduce or prevent radiation energy leakage. In this way, the plasma catalyst does not electrically or magnetically couple with the vessel containing the cavity or to any electrically conductive object outside the cavity. This prevents sparking at the ignition port and prevents radiation from leaking outside the cavity during the ignition and possibly later if the plasma is sustained. In one embodiment, the catalyst can be located at a tip of a substantially electrically non-conductive extender that extends through an ignition port.

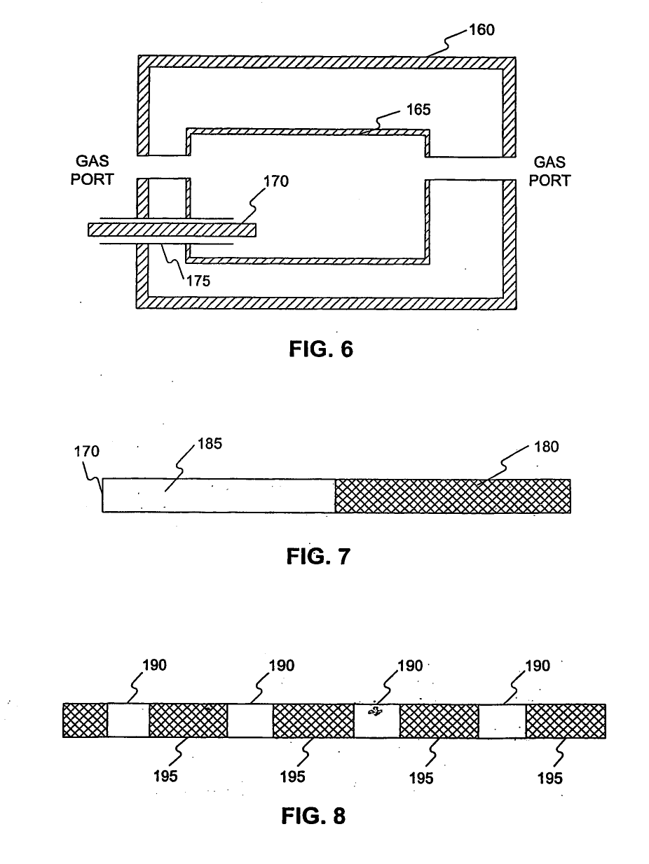

FIG. 6, for example shows radiation chamber 160 in which plasma cavity 165 is placed. Plasma catalyst 170 is elongated and extends through ignition port 175. As shown in FIG. 7, and consistent with this invention, catalyst 170 can include electrically conductive distal portion 180 (which is placed in chamber 160) and electrically non-conductive portion 185 (which is placed substantially outside chamber 160). This configuration prevents an electrical connection (e.g., sparking) between distal portion 180 and chamber 160.

In another embodiment, shown in FIG. 8, the catalyst can be formed from a plurality of electrically conductive segments 190 separated by and mechanically connected to a plurality of electrically non-conductive segments 195. In this embodiment, the catalyst can extend through the ignition port between a point inside the cavity and another point outside the cavity, but the electrically discontinuous profile significantly prevents sparking and energy leakage.

Another method of forming a plasma consistent with this invention includes subjecting an exhaust gas in a cavity to electromagnetic radiation having a frequency less than about 333 GHz in the presence of an active plasma catalyst, which generates or includes at least one ionizing particle.

An active plasma catalyst consistent with this invention can be any particle or high energy wave packet capable of transferring a sufficient amount of energy to a gaseous atom or molecule to remove at least one electron from the gaseous atom or molecule in the presence of electromagnetic radiation. Depending on the source, the ionizing particles can be directed into the cavity in the form of a focused or collimated beam, or they may be sprayed, spewed, sputtered, or otherwise introduced.

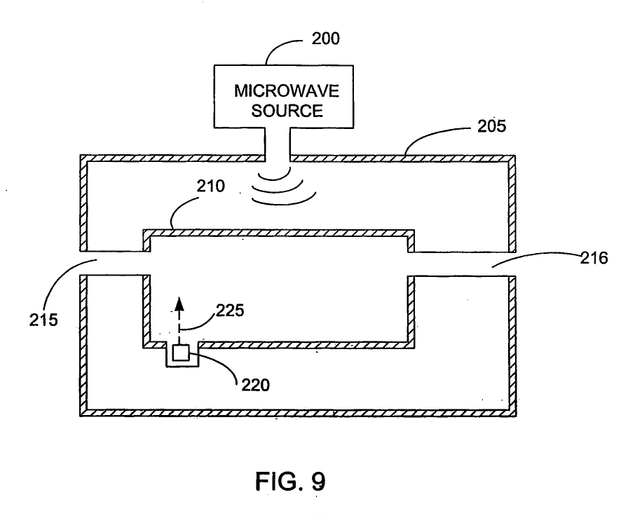

For example, FIG. 9 shows radiation source 200 directing radiation into radiation chamber 205. Plasma cavity 210 is positioned inside of chamber 205 and may permit an exhaust gas to flow therethrough via ports 215 and 216. Source 220 directs ionizing particles 225 into cavity 210. Source 220 can be protected, for example, by a metallic screen which allows the ionizing particles to pass through but shields source 220 from radiation. If necessary, source 220 can be water-cooled.

Examples of ionizing particles consistent with this invention can include x-ray particles, gamma ray particles, alpha particles, beta particles, neutrons, protons, and any combination thereof. Thus, an ionizing particle catalyst can be charged (e.g., an ion from an ion source) or uncharged and can be the product of a radioactive fission process. In one embodiment, the vessel in which the plasma cavity is formed could be entirely or partially transmissive to the ionizing particle catalyst. Thus, when a radioactive fission source is located outside the cavity, the source can direct the fission products through the vessel to ignite the plasma. The radioactive fission source can be located inside the radiation chamber to substantially prevent the fission products (i.e., the ionizing particle catalyst) from creating a safety hazard.

In another embodiment, the ionizing particle can be a free electron, but it need not be emitted in a radioactive decay process. For example, the electron can be introduced into the cavity by energizing the electron source (such as a metal), such that the electrons have sufficient energy to escape from the source. The electron source can be located inside the cavity, adjacent the cavity, or even in the cavity wall. It will be appreciated by those of ordinary skill in the art that the any combination of electron sources is possible. A common way to produce electrons is to heat a metal, and these electrons can be further accelerated by applying an electric field.

In addition to electrons, free energetic protons can also be used to catalyze a plasma. In one embodiment, a free proton can be generated by ionizing hydrogen and, optionally, accelerated with an electric field.

Multi-mode Radiation Cavities

A radiation waveguide, cavity, or chamber can be designed to support or facilitate propagation of at least one electromagnetic radiation mode. As used herein, the term “mode” refers to a particular pattern of any standing or propagating electromagnetic wave that satisfies Maxwell's equations and the applicable boundary conditions (e.g., of the cavity). In a waveguide or cavity, the mode can be any one of the various possible patterns of propagating or standing electromagnetic fields. Each mode is characterized by its frequency and polarization of the electric field and/or the magnetic field vectors. The electromagnetic field pattern of a mode depends on the frequency, refractive indices or dielectric constants, and waveguide or cavity geometry.

A transverse electric (TE) mode is one whose electric field vector is normal to the direction of propagation. Similarly, a transverse magnetic (TM) mode is one whose magnetic field vector is normal to the direction of propagation. A transverse electric and magnetic (TEM) mode is one whose electric and magnetic field vectors are both normal to the direction of propagation. A hollow metallic waveguide does not typically support a normal TEM mode of radiation propagation. Even though radiation appears to travel along the length of a waveguide, it may do so only by reflecting off the inner walls of the waveguide at some angle. Hence, depending upon the propagation mode, the radiation (e.g., microwave) may have either some electric field component or some magnetic field component along the axis of the waveguide (often referred to as the z-axis).

The actual field distribution inside a cavity or waveguide is a superposition of the modes therein. Each of the modes can be identified with one or more subscripts (e.g., TE₁₀ (“tee ee one zero”). The subscripts normally specify how many “half waves” at the guide wavelength are contained in the x and y directions. It will be appreciated by those skilled in the art that the guide wavelength can be different from the free space wavelength because radiation propagates inside the waveguide by reflecting at some angle from the inner walls of the waveguide. In some cases, a third subscript can be added to define the number of half waves in the standing wave pattern along the z-axis.

For a given radiation frequency, the size of the waveguide can be selected to be small enough so that it can support a single propagation mode. In such a case, the system is called a single-mode system (i.e., a single-mode applicator). The TE₁₀ mode is usually dominant in a rectangular single-mode waveguide.

As the size of the waveguide (or the cavity to which the waveguide is connected) increases, the waveguide or applicator can sometimes support additional higher order modes forming a multi-mode system. When many modes are,capable of being supported simultaneously, the, system is often referred to as highly moded.

A simple, single-mode system has a field distribution that includes at least one maximum and/or minimum. The magnitude of a maximum largely depends on the amount of radiation supplied to the system. Thus, the field distribution of a single mode system is strongly varying and substantially non-uniform.

Unlike a single-mode cavity, a multi-mode cavity can support several propagation modes simultaneously, which, when superimposed, results in a complex field distribution pattern. In such a pattern, the fields tend to spatially smear and, thus, the field distribution usually does not show the same types of strong minima and maxima field values within the cavity. In addition, as explained more fully below, a mode-mixer can be used to “stir” or “redistribute” modes (e.g., by mechanical movement of a radiation reflector). This redistribution desirably provides a more uniform time-averaged field distribution within the cavity.

A multi-mode cavity consistent with this invention can support at least two modes, and may support many more than two modes. Each mode has a maximum electric field vector. Although there may be two or more modes, one mode may be dominant and has a maximum electric field vector magnitude that is larger than the other modes. As used herein, a multi-mode cavity may be any cavity in which the ratio between the first and second mode magnitudes is less than about 1:10, or less than about 1:5, or even less than about 1:2. It will be appreciated by those of ordinary skill in the art that the smaller the ratio, the more distributed the electric field energy between the modes, and hence the more distributed the radiation energy is in the cavity.

The distribution of plasma within a processing cavity may strongly depend on the distribution of the applied radiation. For example, in a pure single mode system, there may only be a single location at which the electric field is a maximum. Therefore, a strong plasma may only form at that single location. In many applications, such a strongly localized plasma could undesirably lead to non-uniform plasma treatment or heating (i.e., localized overheating and underheating).

Whether or not a single or multi-mode cavity is used consistent with this invention, it will be appreciated by those of ordinary skill in the art that the cavity in which the, plasma is formed can be completely closed or partially open. For example, in certain applications, such as in plasma-assisted furnaces, the cavity could be entirely closed. See, for example, commonly owned, concurrently filed U.S. patent application Ser. No. 10/___,___ (Attorney Docket No. 1837.0020), which is fully incorporated herein by reference. In other applications, however, it may be desirable to flow a gas through the cavity, and therefore the cavity must be open to some degree. In this way, the flow, type, and pressure of the flowing gas can be varied over time. This may be desirable because certain gases with lower ionization potentials, such as argon, are easier to ignite but may have other undesirable properties during subsequent plasma processing.

Mode-mixing

For many applications, a cavity containing a uniform plasma is desirable. However, because microwave radiation can have a relatively long wavelength (e.g., several tens of centimeters), obtaining a uniform distribution can be difficult to achieve. As a result, consistent with one aspect of this invention, the radiation modes in a multi-mode cavity can be mixed, or redistributed, over a period of time. Because the field distribution within the cavity must satisfy all of the boundary conditions set by the inner surface of the cavity, those field distributions can be changed by changing the position of any portion of that inner surface.

In one embodiment consistent with this invention, a movable reflective surface can be located inside the radiation cavity. The shape and motion of the reflective surface should, when combined, change the inner surface of the cavity during motion. For example, an “L” shaped metallic object (i.e., “mode-mixer”) when rotated about any axis will change the location or the orientation of the reflective surfaces in the cavity and therefore change the radiation distribution therein. Any other asymmetrically shaped object can also be used (when rotated), but symmetrically shaped objects can also work, as long as the relative motion (e.g., rotation, translation, or a combination of both) causes some change in the location or orientation of the reflective surfaces. In one embodiment, a mode-mixer can be a cylinder that is rotatable about an axis that is not the cylinder's longitudinal axis.

Each mode of a multi-mode cavity may have at least one maximum electric field vector, but each of these vectors could occur periodically across the inner dimension of the cavity. Normally, these maxima are fixed, assuming that the frequency of the radiation does not change. However, by moving a mode-mixer such that it interacts with the radiation, it is possible, to move the positions of the maxima. For example, mode-mixer 38 can be used to optimize the field distribution within cavity 12 such that the plasma ignition conditions and/or the plasma sustaining conditions are optimized. Thus, once a plasma is excited, the position of the mode-mixer can be changed to move the position of the maxima for a uniform time-averaged plasma process (e.g., heating).

Thus, consistent with this invention, mode-mixing can be useful during plasma ignition. For example, when an electrically conductive fiber is used as a plasma catalyst, it is known that the fiber's orientation can strongly affect the minimum plasma-ignition conditions. It has been reported, for example, that when such a fiber is oriented at an angle that is greater than 60° to the electric field, the catalyst does little to improve, or relax, these conditions. By moving a reflective surface either in or near the cavity, however, the electric field distribution can be significantly changed.

Mode-mixing can also be achieved by launching the radiation into the applicator chamber through, for example, a rotating waveguide joint that can be mounted inside the applicator chamber. The rotary joint can be mechanically moved (e.g., rotated) to effectively launch the radiation in different directions in the radiation chamber. As a result, a changing field pattern can be generated inside the applicator chamber.

Mode-mixing can also be achieved by launching radiation in the radiation chamber through a flexible waveguide. In one embodiment, the waveguide can be mounted inside the chamber. In another embodiment, the waveguide can extend into the chamber. The position of the end portion of the flexible waveguide can be continually or periodically moved (e.g., bent) in any suitable manner to launch the radiation (e.g., microwave radiation) into the chamber at different directions and/or locations. This movement can also result in mode-mixing and facilitate more uniform plasma processing (e.g., heating) on a time-averaged basis. Alternatively, this movement can be used to optimize the location of a plasma for ignition or other plasma-assisted process.

If the flexible waveguide, is rectangular, a simple twisting of the open end of the waveguide will rotate the orientation of the electric and the magnetic field vectors in the radiation inside the application chamber. Then, a periodic twisting of the waveguide can result in mode-mixing as well as rotating the electric field, which can be used to assist ignition, modulation, or sustaining of a plasma.

Thus, even if the initial orientation of the catalyst is perpendicular to the electric field, the redirection of the electric field vectors can change the ineffective orientation to a more effective one. Those skilled in the art will appreciate that mode-mixing can be continuous, periodic, or preprogrammed.

In addition to plasma ignition, mode-mixing can be useful during subsequent plasma processing to reduce or create (e.g., tune) “hot spots” in the chamber. When a microwave cavity only supports a small number of modes (e.g., less than 5), one or more localized electric field maxima can lead to “hot spots” (e.g., within cavity 12). In one embodiment, these hot spots could be configured to coincide with one or more separate, but simultaneous, plasma ignitions or processing events. Thus, the plasma catalyst can be located at one or more of those ignition or subsequent processing positions.

Multi-location Ignition

A plasma can be ignited using multiple plasma catalysts at different locations. In one embodiment, multiple fibers can be used to ignite the plasma at different points within the cavity. Such multi-point ignition can be especially beneficial when a uniform plasma ignition is desired. For example, when a plasma is modulated at a high frequency (i.e., tens of Hertz and higher), or ignited in a relatively large volume, or both, substantially uniform instantaneous striking and restriking of the plasma can be improved. Alternatively, when plasma catalysts are used at multiple points, they can be used to sequentially ignite a plasma at different locations within a plasma chamber by selectively introducing the catalyst at those different locations. In this way, a plasma ignition gradient can be controllably formed within the cavity, if desired.

Also, in a multi-mode cavity, random distribution of the catalyst throughout multiple locations in the cavity increases the likelihood that at least one of the fibers, or any other passive plasma catalyst consistent with this invention, is optimally oriented with the electric field lines. Still, even where the catalyst is not optimally oriented (not substantially aligned with the electric field lines), the ignition conditions are improved.

Furthermore, because a catalytic powder can be suspended in a gas, it is believed that each powder particle may have the effect of being placed at a different physical location within the cavity, thereby improving ignition uniformity within the cavity.

Dual-Cavity Plasma Igniting/Sustaining

A dual-cavity arrangement can be used to ignite and sustain a plasma consistent with this invention. In one embodiment, a system includes at least a first ignition cavity and a second cavity in fluid communication with the first cavity. To ignite a plasma, a gas in the first ignition cavity can be subjected to electromagnetic radiation having a frequency less than about 333 GHz, optionally in the presence of a plasma catalyst. In this way, the proximity of the first and second cavities may permit a plasma formed in the first cavity to ignite a plasma in the second cavity, which may be sustained with additional electromagnetic radiation.

In one embodiment of this invention, the first cavity can be very small and designed primarily, or solely for plasma ignition. In this way, very little microwave energy may be required to ignite the plasma, permitting easier ignition, especially when a plasma catalyst is used consistent with this invention.

In one embodiment, the first cavity may be a substantially single mode cavity and the second cavity is a multi-mode cavity. When the first ignition cavity only supports a single mode, the electric field distribution may strongly vary within the cavity, forming one or more precisely located electric field maxima. Such maxima are normally the first locations at which plasmas ignite, making them ideal points for placing plasma catalysts. It will be appreciated, however, that when a plasma catalyst is used, it need not be placed in the electric field maximum and, many cases, need not be oriented in any particular direction.

Engine Exhaust Treatment

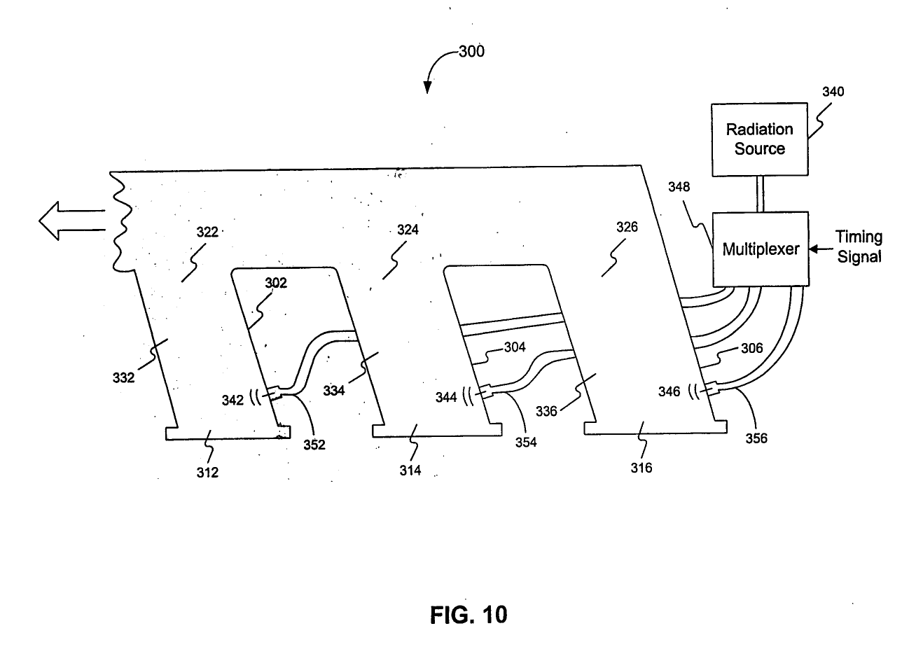

FIG. 10 shows a simplified schematic diagram of illustrative engine exhaust treatment system 300 consistent with this invention. In general, an engine exhaust treatment system can include one or more conduits. And, in the embodiment shown in FIG. 10, system 300 includes conduits 302, 304, and 306. During operation, one or more of the conduits can provide a plasma treatment zone in which a plasma can be formed and used to treat engine exhaust. A conduit consistent with this invention can be any channel, guide, or passageway configured to convey an exhaust gas from an inlet portion to an outlet portion.

Each of conduits 302, 304, and 306 include at least one inlet portion 312, 314, and 316, and at least one outlet portion 322, 324, and 326, respectively. Each of the inlet portions can be configured to connect, directly or indirectly, to an engine block (not shown) and receive engine exhaust gases from one or more combustion regions, zones, or chambers. The number of conduits can correspond, for example, to the number of pistons in an engine. In one embodiment, a single conduit can serve a single combustion region. Alternatively, a single conduit can serve multiple combustion regions. In yet another embodiment, multiple conduits can serve a single combustion region.

The engine block can be any combustion engine for use with any stationary or mobile system, including, for example, a two-stroke engine, a four-stroke engine, or a diesel engine. Examples of mobile systems include vehicles such as cars, buses, trucks, planes, trains, motorcycles, tractors, mobile equipment, or any movable device that includes a combustion engine. Each of conduits 302, 304, and 306 can also include at least one intermediate portion 332, 334, and 336 for conveying gas from inlet portions 312, 314, and 316 to outlet portion 322, 324, and 326, respectively.

Each of conduits 302, 304, and 306 can further include at least one plasma cavity located proximate respective inlet portions 312, 314, and 316 for treating exhaust gas. As used in the context of exhaust treatment systems, a plasma treatment cavity can be any cavity or region in which a plasma can be formed, optionally in the presence of radiation. Thus, a plasma treatment cavity can be the same or different as the intermediate portion of a conduit and it can be integral or separate from the conduit. Moreover, a plasma treatment cavity can be a single-mode cavity or a multi-mode cavity, depending on the particular design constraints of the exhaust treatment system. Furthermore, a plasma treatment cavity can have any convenient length and any convenient cross-section. One or more air inlet ports (not shown) may also be provided at or near the inlet port for feeding air into the system to allow more complete combustion. Similarly, air inlet ports can also be provided at or near the outlet portion of the conduit to act as an after-burner, if desired.

Exhaust treatment system 300 can also include electromagnetic radiation source 340 configured to direct radiation into one or more of plasma cavities 342, 344, and 346 for supplying radiation to the respective cavities. As previously described, the radiation can have any frequency less than about 333 GHz, although radiation having frequencies at the upper end of this range, such as microwave radiation and radio-frequency radiation, have been used to ignite plasmas at atmospheric pressures.

In the embodiment shown in FIG. 10, radiation source 340 can be connected to cavities 342, 344, and 346 using coaxial cables 352, 354, and 356 via multiplexer 348. Due to the high plasma-assisted gas treatment temperatures that can be achieved consistent with this invention, thermal insulators (not shown) can be located between cables 352, 354, and 356 and conduits 302, 304, and 306, respectively, to protect the cables from overheating.

Multiplexer 348 can be used to selectively direct radiation generated by source 340 into any of cavities 342, 344, and 346. In one embodiment, radiation can be directed into the cavities sequentially, and specifically when those cavities include an exhaust gas. In this way, a single low-power radiation source (e.g., source 340) can be shared by multiple plasma processing cavities. Sequential multiplexing consistent with this invention can be synchronized with a timing signal generated by circuitry associated with, for example, an engine's combustion or fuel-injection timing sequence. In another embodiment, radiation source 340 can direct radiation into all of plasma cavities simultaneously, although such simultaneous methods may not be as efficient.

In an alternative embodiment, electromagnetic radiation source 340 can be configured to direct radiation into one or more of plasma cavities 342, 344, and 346 through one or more waveguides (not shown). The shape of the waveguide (e.g., cylindridcal, rectangular, coaxial, elliptical, etc.) can be used to select one or more radiation modes of operation (e.g., TEM, TE, and/or TM) within the respective cavities.

FIG. 11 shows another plasma-assisted exhaust treatment system 400, in which multiple-radiation sources 410, 415, and 420 can be connected directly to each of conduits 402, 404, and 406, thereby eliminating the need for coaxial cables or waveguides. As shown in FIG. 11, each of sources 410, 415, and 420 can be controlled (e.g., triggered) by central controller 425, which may be synchronized to a firing sequence of an engine block.

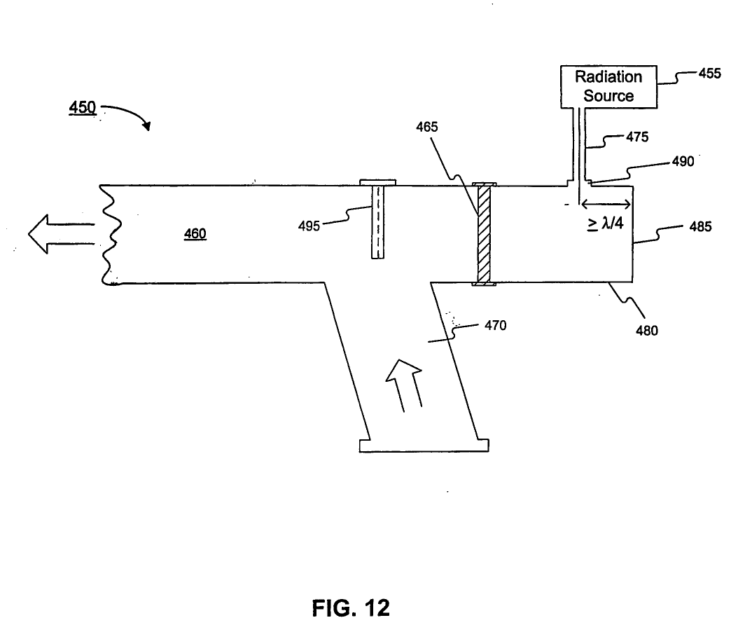

FIG. 12 shows another illustrative embodiment of plasma-assisted gas treatment system 450 consistent with this invention in which radiation source 455 supplies radiation into conduit 460 through radiation-transmissive barrier 465. In this embodiment, exhaust gas can be supplied to conduit 460 through branch 470 of an exhaust manifold. Alternatively, the exhaust gas can be supplied directly through conduit 460, without branch 470. In any case, radiation can be delivered to conduit 460 through at least one of coaxial cable 475 and waveguide 480.

In the embodiment shown in FIG. 12, waveguide 480 can include electrically conductive (e.g., metallic) shorting plate. To optimize the radiation coupling, connector 490 of coaxial cable 475 can be configured to deliver the radiation at a distance from shorting plate 485 of at least about λ/4, where λ is the wavelength of the radiation (e.g., microwave or radio-frequency radiation). Once radiation is directed into waveguide 480, it can propagate into conduit 460 through radiation-transmissive barrier 465, which may be made from ceramic or quartz or any other material substantially transparent to the radiation.

Returning to FIG. 10, plasma cavities 342, 344, and 346 can be located at or near inlet portions 312, 314, and 316, respectively, consistent with this invention. By locating the cavities close to the inlet portions, the temperature of the exhaust gas entering the cavities may not drop significantly. Because the exhaust gas can enter the plasma cavities at a relatively high temperature, the amount of energy required to initiate a plasma from the gas can be relatively small. Thus, Consistent with one embodiment of this invention, one or more plasma cavities can be located along the intermediate portion of the conduit at any position closer to the inlet portion than the outlet portion.

As shown in FIGS. 10 and 11, an exhaust gas treatment system consistent with this invention can include multiple conduits in these embodiments, each of the conduits can have different inlet portions. Also, the outlet portions can be fed into a common conduit, or another outlet portion. Although a separate plasma can be used to treat the exhaust gas in each of the conduits separately, as shown in FIGS. 10 and 11, a single plasma can be used to treat the exhaust gas provided by all of the conduits after they are combined (not shown).

Consistent with one aspect of this invention, any plasma-assisted exhaust gas treatment system consistent with this invention can include a plasma catalyst. As described in detail above, the catalyst can be passive or active. In one embodiment, a plasma catalyst can be located in a cartridge. The cartridge can be removable, replaceable, or disposable. It can also be reloadable and reusable. For example, as shown in FIG. 12, cartridge 495 can include a catalyst support structure that can be inserted and removed from conduit 460. In this embodiment, cartridge 495 can include a consumable plasma catalyst (e.g., carbon fiber, a radiation source, etc.) that can be replaced when no longer effective.

Conduit 460 can also include an exhaust gas monitor (not shown) capable of determining whether the plasma catalyst is effective. A plasma catalyst would be considered effective when, for example, a plasma quickly ignites in the presence of exhaust gas and a sufficient amount of radiation. An oxygen or carbon monoxide sensor, for example, can be used to monitor the composition of the exhaust gas at an outlet portion of a conduit. If the exhaust gas composition is determined to be unacceptable, a signal can be generated and used to notify a user, such as a motor vehicle operator that maintenance is required.

Thus, passive and active plasma catalysts consistent with this invention can be used to ignite, modulate, and/or sustain an exhaust plasma at atmospheric pressures with a reduced amount of radiation power. In general, the method for using such a catalyst includes forming at least one plasma from an engine exhaust gas by subjecting the exhaust gas to electromagnetic radiation having a frequency less than about 333 GH in the presence of a plasma catalyst in at least one cavity.

One advantage of using plasma catalysts consistent with this invention is the ability to quickly achieve effective operating temperature. That is, it is possible to achieve a plasma with a sufficiently high operating temperature in a period of time or less than about five seconds measured from a time of plasma formation, or even less than about one second. Of course the exact amount of time depends on the desired operating temperature, the gas flow rate, the electromagnetic radiation power, etc. For example, an operating temperature greater than about 1,000 degrees Celsius, or greater than about 2,500 degrees Celsius can be very quickly obtained without the use of vacuum equipment. Another advantage can be the rate and ease that a plasma can be restruck using a plasma catalyst. This can be particularly useful when sequential multiplexing of radiation, as shown in FIG. 10, for example, is used.

In one embodiment consistent with this invention, the conduit, in whole or in part, can itself act as a plasma cavity. Thus, an engine exhaust treatment system can include at least one conduit, and at least one of those conduits can include an inlet portion configured to connect to an engine block and receive an engine exhaust gas, an outlet portion for emitting the gas, and an intermediate portion for conveying the gas from the inlet portion to the outlet portion and having internal dimensions configured to support at least one electromagnetic radiation mode for forming a plasma therein from the exhaust gas. The system can also include a source for supplying electromagnetic radiation to the intermediate portion, wherein the radiation can have a frequency less than about 333 GHz.

In one embodiment, the plasma cavity, or at least a portion of the conduit, has a coaxial form. Thus, the cavity can be formed between an inner tube and an outer tube, although other shapes and configurations are also possible. It will be appreciated that the tubes can be electrically conductive (e.g., metallic) or insulating (e.g., ceramic). When a coaxial configuration is used, electromagnetic radiation can be provided into the plasma cavity with, for example, a waveguide or a coaxial cable. In the case of a coaxial cable, the radiation can be provided by attaching the cable axially. If the internal dimensions of the coaxial cable are different from the internal dimensions of the coaxial conduit, a tapered connector can be used to make the internal surfaces substantially flush to help prevent reflection of the radiation.

The system can also include a source for supplying electromagnetic radiation to the intermediate portion, wherein the radiation can have a frequency less than about 333 GHz.

Thus, the internal dimensions of a conduit can be configured to act as an optimized waveguide for the radiation, and thus for igniting, modulating, or sustaining an exhaust plasma consistent with this invention.

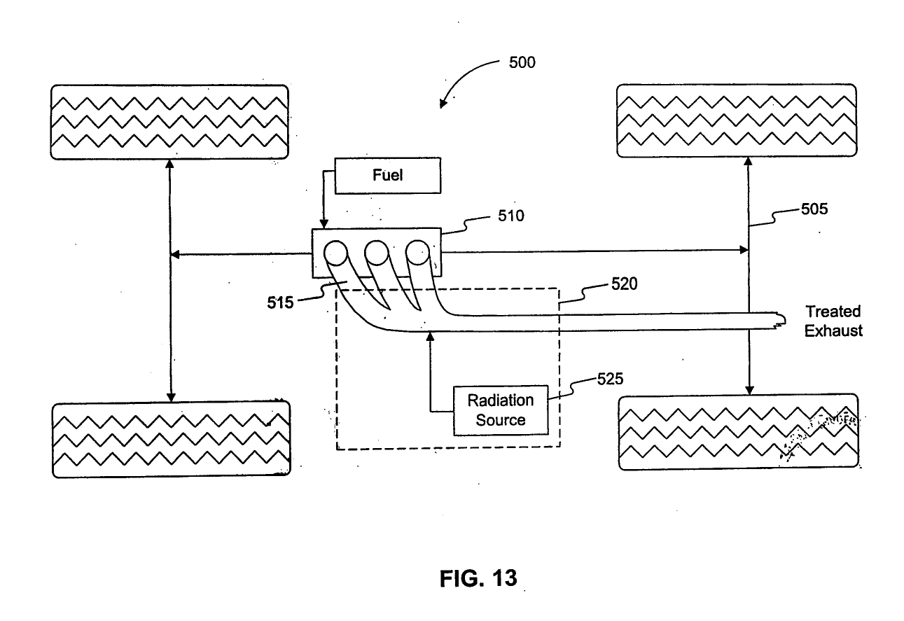

As mentioned above, any type of mobile vehicle that includes a combustion engine can be used with an engine exhaust treatment system consistent with this invention. For example, a mobile vehicle, or system, can be a car, a bus, a truck, a plane, a train, a motorcycle, a tractor, mobile equipment, or any other movable device powered by a combustion engine. Thus, as shown in FIG. 13, a mobile vehicle, in this case automobile 500, can include at least some sort of chassis 505, combustion engine 510, conduit 515 connected to engine 510 for evacuating combustion gases from engine 510, and exhaust treatment system 520 consistent with this invention. Exhaust treatment system 520 can include, among other things, electromagnetic radiation source 525 for directing radiation into the conduit. System 520 can also include a plasma catalyst (not shown in FIG. 13) for catalyzing the plasma consistent with this invention.

In the foregoing described embodiments, various features are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description of Embodiments, with each claim standing on its own as a separate preferred embodiment of the invention.

We claim:

1. An engine exhaust treatment system comprising:
at least one conduit comprising:
an inlet portion configured to connect to an engine block and receive an engine exhaust gas,
an outlet portion for emitting the gas, and
an intermediate portion for conveying the gas from the inlet portion to the outlet portion, wherein the intermediate portion including a plasma cavity located proximate to the inlet portion for treating the gas; and
an electromagnetic radiation source configured to direct radiation into the cavity, wherein the radiation has a frequency less than about 333 GHz.

2. The system of claim 1, wherein the cavity is located at the inlet portion.

3. The system of claim 1, wherein the cavity is located along the intermediate portion at a position closer to the inlet portion than the outlet portion.

4. The system of claim 1, further comprising at least one of a passive plasma catalyst and an active plasma catalyst located in the radiation.

5. The system of claim 4, wherein the plasma catalyst is located in a cartridge configured to be removable, from the cavity.

6. The system of claim 4, wherein the plasma catalyst comprises at least one passive plasma catalyst comprising a material that is at least electrically semi-conductive.

7. The system of claim 6, wherein the plasma catalyst is coated with a protective layer to help prevent the catalyst from being consumed by the plasma.

8. The system of claim 6, wherein the material comprises at least one of metal, inorganic material, carbon, carbon-based alloy, carbon-based composite, electrically conductive polymer, conductive silicone elastomer, polymer nanocomposite, and organic-inorganic composite.

9. The system of claim 8, wherein the material is in the form of at least one of a nano-particle, a nano-tube, a powder, a dust, a flake, a fiber, a sheet, a needle, a thread, a strand, a filament, a yarn, a twine, a shaving, a sliver, a chip, a woven fabric, a tape, and a whisker.

10. The system of claim 9, wherein the catalyst comprises carbon fiber.

11. The method of claim 9, wherein the catalyst is in the form of at least one of a nano-particle, a nano-tube, a powder, a dust, a flake, a fiber, a sheet, a needle, a thread, a strand, a filament, a yarn, a twine, a shaving, a sliver, a chip, a woven fabric, a tape, and a whisker.

12. The system of claim 8, wherein the plasma catalyst comprises a powder.

13. The system of claim 4, wherein the plasma catalyst is an active plasma catalyst comprising at least one ionizing particle.

14. The system of claim 13, wherein the at least one ionizing particle comprises a beam of particles.

15. The system of claim 13, wherein the particle is at least one of an x-ray particle, a gamma ray particle, an alpha particle, a beta particle, a neutron, and a proton.

16. The system of claim 13, wherein the ionizing particle comprises a radioactive fission product.

17. The system of claim 13, wherein the plasma can form in the cavity at a pressure that is at least atmospheric pressure.

18. The system of claim 1, wherein the at least one conduit comprises a plurality of conduits.

19. The system of claim 18, wherein each of the plurality of conduits has differing inlet portions and shares a common outlet portion.

20. The system of claim 1, wherein the cavity is arranged at a location so that, in use, a temperature of the gas entering the cavity is approximately the same as the temperature of the gas at the inlet portion.

21. A method for treating engine exhaust gas, the method comprising forming at least one plasma from an engine exhaust gas by subjecting the exhaust gas to electromagnetic radiation having a frequency less than about 333 GHz in the presence of a plasma catalyst in at least one cavity.

22. The method of claim 21, further comprising obtaining an effective operating temperature in a period of time of less than about five seconds measured from a time of plasma formation.

23. The method of claim 22, wherein the period of time is less than about one second.

24. The method of claim 21,,wherein the at least one cavity comprises a plurality of cavities configured to be individually connected to a respective combustion region, and wherein each of the cavities is configured to be in fluid communication with each other so that the exhaust gas flowing from each of the cavities combines during operation.

25. The method of claim 21, wherein the gas has a first temperature upon exiting a combustion region, the method further comprising directing the exhaust gas into the cavity before the temperature significantly drops from the first temperature.

26. The method of claim 25, wherein the plasma has a temperature greater than about 1,000 degrees Celsius.

27. The method of claim 24, wherein the plasma has a temperature greater than about 2,500 degrees Celsius.

28. The method of claim 21, wherein the at least one cavity is located along at least one conduit, the conduit comprising an inlet portion configured to connect to an engine block and receive the engine exhaust gas, an outlet portion for emitting the gas, and an intermediate portion for conveying the gas from the inlet portion to the outlet portion, wherein each cavity is located near the inlet portion of its respective conduit.

29. The method of claim 28, wherein each conduit has a differing inlet portion and shares a common outlet portion.

30. The method of claim 22, cavity is in the inlet portion.

31. The method of claim 22, wherein the cavity is located closer to the inlet portion than the outlet portion.

32. The method of claim 21, wherein the plasma catalyst comprises at least one of a passive plasma catalyst and an active plasma catalyst.

33. The system of claim 32, wherein the plasma catalyst comprises at least one passive plasma catalyst comprising a material that is at least electrically semi-conductive.

34. The method of claim 33, wherein the material comprises at least one of metal, inorganic material, carbon, carbon-based alloy, carbon-based composite, electrically conductive polymer, conductive silicone elastomer, polymer nanocomposite, and organic-inorganic composite.

35. The method of claim 32, wherein the material is in the form of at least one of a nano-particle, a nano-tube, a powder, a dust, a flake, a fiber, a sheet, a needle, a thread, a strand, a filament, a yarn, a twine, a shaving, a sliver, a chip, a woven fabric, a tape, and a whisker.

36. The system of claim 35, wherein the plasma catalyst comprises a powder.

37. The method of claim 32, wherein the plasma catalyst is an active plasma catalyst comprising at least one ionizing particle.

38. The method of claim 37, wherein the at least one ionizing particle comprises a beam of particles.

39. The method of claim 32, wherein the particle is at least one of an x-ray particle, a gamma ray particle, an alpha particle, a beta particle, a neutron, and a proton.

40. The method of claim 21, wherein the plasma can form in the cavity at a pressure that is at least atmospheric pressure.

41. The method of claim 21, wherein a first combustion region and a second combustion region generate a first portion and a second portion of the exhaust gas, respectively, according to a predetermined timing sequence, the method further comprising exposing the first and second portions of the exhaust gas with the radiation in a manner that is synchronized with the timing sequence.

42. An engine exhaust treatment system comprising:
at least one conduit comprising:
an inlet portion configured to connect to an engine block and receive an engine exhaust gas,
an outlet portion for emitting the gas, and
an intermediate portion for conveying the gas from the inlet portion to the outlet portion and having internal dimensions configured to support at least one electromagnetic radiation mode for forming a plasma therein from the exhaust gas in the presence of a plasma catalyst; and
a source for supplying electromagnetic radiation to the intermediate portion, wherein the radiation has a frequency less than about 333 GHz.

43. The system of claim 42, further comprising a coaxial cable connected between the source and the conduit.

44. The system of claim 43, further comprising a waveguide between the cable and the conduit.

45. The system of claim 42, further comprising at least one radiation filter located proximate the inlet portion to help prevent the radiation from passing out of the conduit.

46. The system of claim 42, further comprising at least one radiation filter located proximate the outlet portion to help prevent the radiation from passing out of the conduit.

47. The system of claim 42, wherein the internal dimensions are configured to act as an optimized waveguide for the radiation.

48. The system of claim 42, wherein the at least one conduit comprises at least a first conduit configured to be connected with a first combustion region and a second conduit configured to be connected with a second combustion region, the system further comprising a controller for causing a first portion of the exhaust gas in the first conduit to be exposed to the radiation and for causing a second portion of the exhaust gas in the second conduit to be exposed to the radiation according to a predetermined timing sequence.

49. The system of claim. 48, wherein the predetermined timing sequence causes only one of the exhaust gas portions to be exposed at any one time.

50. The system of claim 42, wherein the conduit has a coaxial shape.

51. The system of claim 50, wherein the source is connected to the conduit with a coaxial cable.

52. The system of claim 51, wherein the coaxial cable has internal cross-sectional dimensions and the coaxial conduit has internal cross-sectional dimensions that are -different from the internal cross-sectional dimensions of the coaxial-cable, the system further comprising a tapered connector can be used to make the connection between the cable and the conduit substantially flush.

53. The vehicle of claim 42, wherein the conduit includes at least one air port for allowing air to enter the conduit and further combust the gas before the gas is conveyed to the outlet.

54. A mobile vehicle comprising:
a chassis;
a combustion engine connected to the chassis;
an engine exhaust treatment system configured to receive exhaust gases from the engine, wherein the system comprises at least one conduit, where the conduit that includes an inlet portion configured to connect to an engine block and receive an engine exhaust gas, an outlet portion for emitting the gas, and an intermediate portion for conveying the gas from the inlet portion to the outlet portion;
at least one plasma cavity located proximate the inlet portion for treating the gas; and
an electromagnetic radiation source configured to supply radiation to the cavity, wherein the radiation has a frequency less than about 333 GHz.

55. The vehicle of claim 54, wherein the vehicle is an automobile.

56. The vehicle of claim 54, further comprising a plasma catalyst in the radiation.

57. The vehicle of claim 56, wherein the plasma catalyst comprises ant least one of an active plasma catalyst and an active plasma catalyst.

58. The vehicle of claim 56, wherein the plasma catalyst comprises carbon fiber.

59. The vehicle of claim 54, wherein the conduit includes at least one air port for allowing air to enter the conduit and further combust the gas.
